(19) United States
(12) Patent Application Publication
(10) Pub. No.: US 2026/0292000 A1
(43) Pub. Date: Sep. 24, 2026

(54) SYSTEM FOR DETECTING UNLAWFUL INTERNET EXPRESSIONS

(71) Applicant: SoftBank Group Corp., Tokyo (JP)

(72) Inventor: Noriyuki KASAI, Tokyo (JP)

(21) Appl. No.: 19/564,171

(22) Filed: Mar. 12, 2026

Related U.S. Application Data
(60) Provisional application No. 63/773,486, filed on Mar. 18, 2025.

(51) Int. Cl. H04L 9/40; G06F 40/289; G06F 40/30

(52) U.S. Cl. CPC H04L 63/306; G06F 40/289; G06F 40/30

(57) ABSTRACT

A system includes an input monitoring unit, a context analysis unit, a bullying/law violation detection unit, an alert display unit, and a log recording unit. The input monitoring unit captures a character string in real time when a user inputs characters using a messaging application or SNS. The context analysis unit analyzes the context of the input character string using natural language processing technology and determines content that may be an aggressive expression or violate the law. The bullying/law violation detection unit refers to a database on a server and determines whether the input content is related to bullying. The alert display unit displays a warning to the user and prompts reconsideration of the input content. The log recording unit records the detected content and the history of alerts so that parents or educational institutions can check them later.

### CROSS-REFERENCE TO RELATED APPLICATIONS

This application is based upon and claims the benefit of priority from U.S. Provisional Patent Application No. 63/773486, filed on Mar. 18, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to prevent children from being involved in bullying or criminal acts when using smartphones. In modern society, with the spread of smartphones and the Internet, children have become able to easily communicate with others, but on the other hand, the risk of bullying and inappropriate behavior occurring online has also increased. In particular, since children do not yet have sufficient social experience or knowledge of the law, they may unintentionally make statements that hurt others. There is also a possibility that they may take actions that violate the law.

In such a situation, it is required to detect in real time whether the content of a message may lead to bullying or violate the law before children send a message containing inappropriate content, and to issue a warning. Disclosed herein is to prevent children from taking inappropriate actions and to promote healthy communication by providing a system that operates on a smartphone.

Furthermore, this system also functions as a tool for parents and educational institutions to appropriately monitor and guide children's online activities. Through a log function, the detected content and the history of alerts can be recorded and checked later, making it possible to understand children's behavior and provide appropriate guidance as needed. In this way, by providing an environment where children can safely use smartphones, the occurrence of bullying and criminal acts is prevented.

Disclosed herein is a system including an input monitoring unit, a context analysis unit, a bullying/law violation detection unit, an alert display unit, and a log recording unit. This system operates on a smartphone and monitors the content in real time when a user inputs characters. The input monitoring unit immediately captures a character string input by a user in a messaging application, SNS, or the like, and transmits it to the context analysis unit.

The context analysis unit analyzes the context of the input character string using natural language processing technology and generates information for determining whether the text includes an intention or an aggressive expression. This analysis result is sent to the bullying/law violation detection unit, which refers to a pre-built database to determine whether the input content includes keywords or phrases related to bullying, or expressions that may violate the law.

Based on the detection result, the alert display unit displays a visually conspicuous alert to the user to prompt reconsideration of the input content. The alert indicates a specific problem and prompts the user to check the content before sending. Furthermore, the log recording unit records the detected content and the display history of alerts in the device so that parents or educational institutions can check them later. In this way, it becomes possible to prevent children from taking inappropriate actions and to promote healthy communication.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example method of detecting an expression having a possibility of violating a law.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5 th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

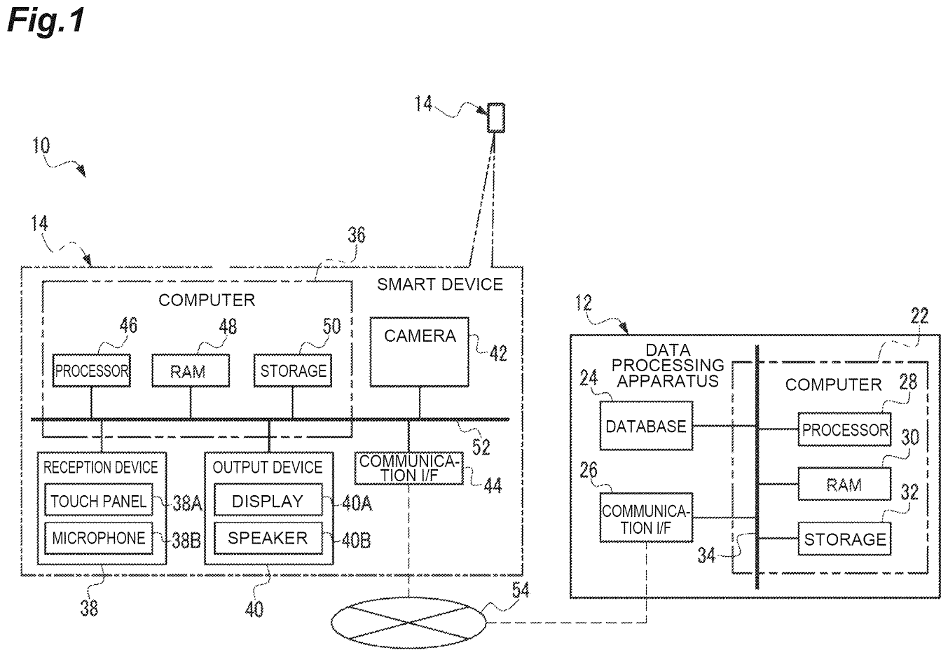

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

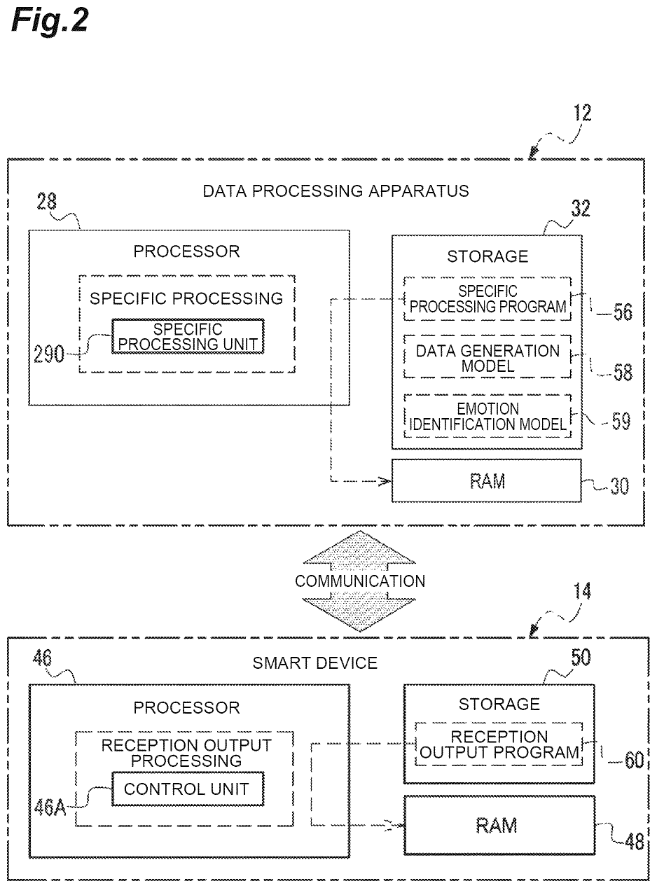

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

A system configuration using a server and a terminal will be described in further detail. This system operates by linking a terminal such as a smartphone with a server on the cloud in order to prevent bullying and criminal acts.

The system configuration is not limited to simple communication between a client and a server, and may adopt a hybrid processing architecture to which edge computing technology is applied. For example, a lightweight first inference model with a low calculation load (e.g., a quantized neural network or a Bloom filter) may be implemented in the smart device 14 (edge side), and a second inference model with high accuracy and a high calculation load (e.g., a large language model) may be implemented in the data processing apparatus 12 (cloud side).

First, an input monitoring unit and an alert display unit are implemented on the terminal side. The input monitoring unit captures a character string in real time when a user inputs characters in a messaging application, SNS, or the like. This function is realized by hooking the keyboard input of the terminal, and starts operating immediately when the user starts inputting. For example, when the user inputs “I will hit you,” this character string is immediately captured. The input monitoring unit cooperates with the operating system of the terminal and operates in the background, so it can acquire the character string without interfering with the user's operation.

The input monitoring unit may perform primary screening of an input character string using the first inference model within the device. Only when the first inference model calculates a score (such as an aggression score) exceeding a predetermined threshold, the character string may be encrypted and transmitted to the data processing apparatus 12, where detailed analysis by the second inference model may be performed. With this configuration, compared to a case where all text data is constantly transmitted to the server, it becomes possible to significantly reduce consumption of network bandwidth and reduce the load on calculation resources on the server side. This produces a technical effect of preventing detection omission due to communication delay (latency) in a monitoring system where real-time performance is required.

The input monitoring unit may be configured by, for example, the computer 36 (the processor 46, etc.) and the reception device 38 (the touch panel 38A, the microphone 38B, etc.) of the smart device 14.

The captured character string is transmitted from the terminal to the server. This transmission is performed securely using encryption technology to protect the user's privacy. A context analysis unit and a bullying/law violation detection unit are implemented on the server side. The context analysis unit analyzes the context of the character string transmitted to the server using natural language processing technology. For example, it analyzes the meaning of words and the structure of sentences to determine whether the text includes an aggressive expression or intent. For example, the phrase “I will hit you” is determined to have a potentially aggressive intent. The context analysis unit uses a machine learning algorithm to analyze the nuance and emotion of the input text to make a more accurate determination.

In a processing algorithm in the context analysis unit, for example, an input character string may be first tokenized and converted into vector data on a multidimensional vector space (Embedding Space). The context analysis unit may calculate a dependency between input words using a self-attention mechanism based on a Transformer architecture to generate a context vector.

The context analysis unit may calculate a cosine similarity between the generated context vector and a “bullying/crime concept vector” stored in the database 24. This calculation is impossible to perform as a human mental process and is realized by high-speed matrix operations by the processor 28. The context analysis unit includes a recurrent neural network (RNN) or an LSTM (Long Short-Term Memory) that holds a past conversation history as time-series data, and may detect not only a single sentence but also a transition of emotion in the flow of conversation (e.g., a sudden change from calm to enraged) as an anomaly in a vector trajectory.

The context analysis unit may be configured by, for example, the computer 22 (the processor 28, etc.) of the data processing apparatus 12, or may be configured by the specific processing unit 290, the specific processing program 56, the data generation model 58, and the like.

Next, the bullying/law violation detection unit determines, based on the information from the context analysis unit, whether the input content has the potential to lead to bullying or to violate the law. A database built on the server is used for this determination. This database registers keywords and phrases related to bullying, and expressions that may violate the law. For example, if violent words such as “hit” or “kill,” or words suggesting criminal acts such as “steal” or “fraud” are included, the system detects them. Furthermore, the database is periodically updated to be able to respond to new trends and expressions.

The bullying/law violation detection unit may be configured by, for example, the computer 22 (the processor 28, etc.) of the data processing apparatus 12 and the database 24, or may be configured by the specific processing unit 290, the specific processing program 56, the data generation model 58, and the like.

The detection result is transmitted from the server to the terminal, and the alert display unit displays a visually conspicuous alert to the user. The alert indicates a specific problem and prompts the user to reconsider the input content. For example, content such as “This message may contain aggressive content. Please check again before sending.” is displayed. The alert display unit cooperates with the user interface to warn the user using a pop-up message or a notification bar.

In addition to the warning display by the alert display unit, the system may generate a control signal for directly controlling hardware functions of the smart device 14 based on a detection result. For example, when the bullying/law violation detection unit determines that “urgency is high (e.g., a notice of physical harm),” the processor 46 may control the communication I/F 44 to block (drop) a transmission packet of the message at a network layer. The processor 46 may temporarily lock (disable) a keyboard input interface via an API of an operating system to cause a transition to a state in which physical input is not accepted for a certain period of time. Such physical device control imparts properties as a specific machine control system to the system, going beyond mere presentation of information (Abstract Idea).

The alert display unit may be configured by, for example, the output device 40 (the display 40A, the speaker 40B, etc.) of the smart device 14.

Furthermore, a log recording unit records the detected content and the display history of alerts in the terminal. This log includes the date and time, the input content, the detected problem, and the content of the displayed alert, so that parents or educational institutions can check them later. For example, if a child inputs “I will hit you” and an alert is displayed, that history is recorded, and a parent can check it later. The log recording unit considers data protection and privacy, and performs access control so that only authorized users can view the log.

The log recording unit may be configured by, for example, the computer 36 (the processor 46, the RAM 48, the storage 50, etc.) of the smart device 14.

In this way, by linking a server and a terminal, healthy communication is promoted to prevent children from taking inappropriate actions. The entire system is designed with scalability in mind and is built to operate stably even when a large number of users use it simultaneously. This enables widespread adoption in educational institutions and homes, and is expected to contribute to the suppression of bullying and criminal acts in society as a whole.

### System Configuration

The system includes an input monitoring unit, a context analysis unit, a bullying/law violation detection unit, an alert display unit, and a log recording unit. The input monitoring unit has a function of capturing a character string in real time when a user inputs characters using a messaging application or SNS on a terminal such as a smartphone or a tablet. This unit cooperates with the operating system of the terminal and operates in the background, so it can acquire the character string without interfering with the user's operation. For example, when a user inputs an aggressive phrase such as “I will hit you,” the input monitoring unit immediately captures that character string and transmits it to the next processing step. Furthermore, the input monitoring unit can also infer the user's emotional state by analyzing the input speed and frequency. For example, if the input speed suddenly increases, it can be determined that the user may be emotional.

The context analysis unit operates on a server and analyzes the character string transmitted from the input monitoring unit using natural language processing technology. This unit analyzes the meaning of words and the structure of sentences to determine whether the text includes an intention or an aggressive expression. For example, the phrase “I will hit you” is determined to have a potentially aggressive intent. The context analysis unit uses a machine learning algorithm to analyze the nuance and emotion of the input text to make a more accurate determination. For example, it can infer what kind of emotion the input text is expressing using a model based on past data. For example, even with the same word “hit,” it may be used as a joke depending on the context, so it is required to distinguish that difference.

The bullying/law violation detection unit determines, based on the information from the context analysis unit, whether the input content has the potential to lead to bullying or to violate the law. This unit uses a database built on the server and refers to keywords and phrases related to bullying, and expressions that may violate the law. For example, if violent words such as “hit” or “kill,” or words suggesting criminal acts such as “steal” or “fraud” are included, the system detects them. Furthermore, the database is periodically updated to be able to respond to new trends and expressions. For example, by also taking into account new slang popular among young people and unique expressions used in specific cultural spheres, more comprehensive detection becomes possible.

The alert display unit displays a visually conspicuous alert to the user based on the detection result. This unit indicates a specific problem and prompts the user to reconsider the input content. For example, content such as “This message may contain aggressive content. Please check again before sending.” is displayed. The alert display unit cooperates with the user interface to warn the user using a pop-up message or a notification bar. Furthermore, the design and display method of the alert can be customized according to the user's age and usage situation, and for example, more intuitive and easy-to-understand icons and colors can be used for children.

The log recording unit records the detected content and the display history of alerts in the terminal. This unit generates a log including the date and time, the input content, the detected problem, and the content of the displayed alert, so that parents or educational institutions can check them later. For example, if a child inputs “I will hit you” and an alert is displayed, that history is recorded, and a parent can check it later. The log recording unit considers data protection and privacy, and performs access control so that only authorized users can view the log. Furthermore, the log data is also utilized as material for educational institutions to analyze student behavior and provide appropriate guidance. For example, if a specific student repeatedly uses aggressive words, individual counseling can be provided to that student.

Specific examples of prompt sentences to be read into the generative AI include “Please determine whether this sentence has an aggressive intent,” “Please evaluate whether this phrase has the potential to violate the law,” and “Please analyze the emotional nuance of this message.” These prompt sentences serve as guidelines for the AI to appropriately analyze the input text and make an accurate judgment.

### Implementation Steps

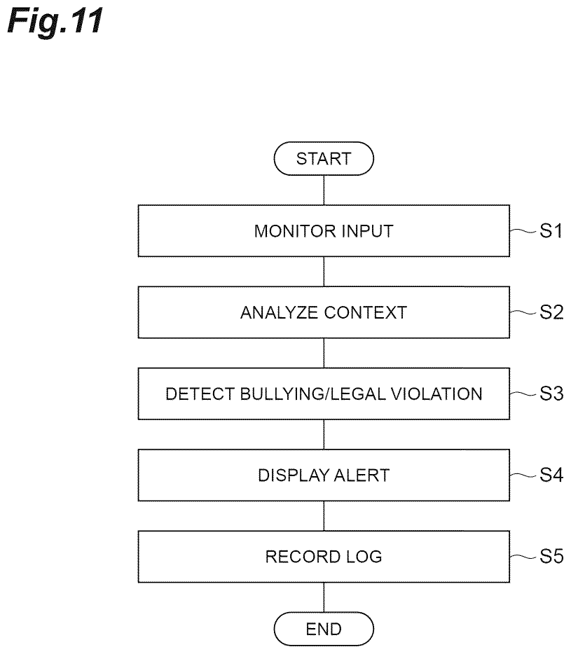

### Step 1: Input Monitoring (Refer to Step S1 of FIG. 11)

When a user inputs characters using a messaging application or SNS on a terminal such as a smartphone or a tablet, the input monitoring unit captures the character string in real time. In this step, the unit cooperates with the operating system of the terminal and operates in the background, so it can acquire the character string without interfering with the user's operation. For example, when a user inputs an aggressive phrase such as “I will hit you,” the input monitoring unit immediately captures that character string and transmits it to the next processing step. Furthermore, the input monitoring unit can also infer the user's emotional state by analyzing the input speed and frequency.

### Step 2: Context Analysis (Refer to Step S2 of FIG. 11)

The captured character string is transmitted to a server and analyzed by a context analysis unit using natural language processing technology. In this step, the meaning of words and the structure of sentences are analyzed to determine whether the text includes an intention or an aggressive expression. For example, the phrase “I will hit you” is determined to have a potentially aggressive intent. The context analysis unit uses a machine learning algorithm to analyze the nuance and emotion of the input text to make a more accurate determination. A specific example of a prompt sentence to be read into the generative AI is “Please determine whether this sentence has an aggressive intent.”

### Step 3: Detection of Bullying/Law Violation (Refer to Step S3 of FIG. 11)

Based on the information from the context analysis unit, the bullying/law violation detection unit determines whether the input content has the potential to lead to bullying or to violate the law. In this step, a database built on the server is used, and keywords and phrases related to bullying, and expressions that may violate the law are referred to. For example, if violent words such as “hit” or “kill,” or words suggesting criminal acts such as “steal” or “fraud” are included, the system detects them. A specific example of a prompt sentence to be read into the generative AI is “Please evaluate whether this phrase has the potential to violate the law.”

### Step 4: Alert Display (Refer to Step S4 of FIG. 11)

Based on the detection result, the alert display unit displays a visually conspicuous alert to the user. In this step, a specific problem is indicated, and the user is prompted to reconsider the input content. For example, content such as “This message may contain aggressive content. Please check again before sending.” is displayed. The alert display unit cooperates with the user interface to warn the user using a pop-up message or a notification bar.

### Step 5: Log Recording (Refer to Step S5 of FIG. 11)

The log recording unit records the detected content and the display history of alerts in the terminal. In this step, a log including the date and time, the input content, the detected problem, and the content of the displayed alert is generated, so that parents or educational institutions can check them later. For example, if a child inputs “I will hit you” and an alert is displayed, that history is recorded, and a parent can check it later. The log recording unit considers data protection and privacy, and performs access control so that only authorized users can view the log.

### Specific Use Case

For example, in a certain educational institution, the system is introduced when students communicate online using smartphones. This system has an input monitoring unit that captures character strings in real time and transmits them to a context analysis unit when students interact with other students through messaging applications or SNS. The context analysis unit analyzes the context of the input character string using natural language processing technology and determines aggressive expressions or content that may violate the law.

For example, when a student inputs an aggressive phrase such as “I will hit you,” the context analysis unit determines that the phrase has a potentially aggressive intent and transmits the information to the bullying/law violation detection unit. The bullying/law violation detection unit refers to a database on the server and confirms that the phrase is a keyword related to bullying. Based on this result, the alert display unit displays an alert to the student saying “This message may contain aggressive content. Please check again before sending.” and prompts reconsideration of the input content.

Furthermore, a log recording unit records this series of processes and saves a log including the date and time, the input content, the detected problem, and the content of the displayed alert. This log is designed to be checkable later by the administrator of the educational institution and is utilized as material for analyzing student behavior and providing appropriate guidance as needed.

Specific examples of prompt sentences to be read into the generative AI include “Please determine whether this sentence has an aggressive intent,” “Please evaluate whether this phrase has the potential to violate the law,” and “Please analyze the emotional nuance of this message.” These prompt sentences serve as guidelines for the AI to appropriately analyze the input text and make an accurate judgment.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

An advanced monitoring system for enhancing security within a facility detects abnormal behavior and suspicious persons by analyzing video data from surveillance cameras in real time. The system includes a video data acquisition unit, a video analysis unit, an action analysis unit, an anomaly detection unit, an alert display unit, and a log recording unit.

First, the video data acquisition unit acquires video data in real time from a plurality of surveillance cameras installed within the facility. These cameras are strategically placed in security-critical areas such as entrances/exits, corridors, elevators, parking lots, emergency stairs, and rooftops. For example, a camera installed at an entrance/exit records all persons entering and exiting the facility and identifies specific persons using face recognition technology. Also, a camera installed in a corridor tracks the movement of persons moving within the facility and detects movements that deviate from normal flow lines. Furthermore, a camera installed in a parking lot is used to monitor the entry and exit of vehicles and to detect suspicious movements. This makes it possible to grasp the overall movement within the facility and to discover abnormal behavior early.

Next, the video analysis unit processes the acquired video data and identifies persons and objects in the video using image recognition technology. For example, it can identify a specific person and track their movement using face recognition technology. It can also detect belongings and vehicles using object recognition technology. This analysis makes it possible to grasp the dynamic elements in the video in detail. Furthermore, by integrating data from multiple cameras and performing three-dimensional motion analysis, the overall situation within the facility is grasped, and more accurate monitoring is realized. For example, by combining video from multiple cameras, it is possible to three-dimensionally reproduce how a person is moving within the facility and to identify movements that are different from normal.

The action analysis unit analyzes patterns of movement of persons and objects based on the data from the video analysis unit. For example, it detects movements that deviate from normal flow lines or actions of staying in a specific area for a long time. Furthermore, it analyzes the speed and direction of movement and identifies actions that are different from normal. For example, it can detect a person moving in a zigzag pattern in a corridor where they should normally move in a straight line. It is also possible to detect unnatural movements in a specific area or a person walking around inside the facility outside of normal business hours. This makes it possible to discover potential threats early and to take appropriate action.

The anomaly detection unit determines the possibility of abnormal behavior or a suspicious person based on the information from the action analysis unit. For example, if a specific behavior pattern that matches past criminal behavior is detected, a warning can be issued immediately. Also, it is periodically updated by referring to a database on a server so as to be able to respond to new trends and expressions. This makes it possible to achieve comprehensive detection by also taking into account new slang popular among young people and unique expressions used in specific cultural spheres. For example, if a specific gesture or movement is a sign of a new criminal behavior, it can be immediately detected and a warning can be issued.

The alert display unit issues a warning to security personnel based on the detection result. The alert is displayed on a surveillance monitor, and notification by voice or vibration is also possible. For example, when abnormal behavior is detected in a specific area, a warning message is displayed along with detailed video of that area. This allows the personnel to quickly grasp the situation on site and take appropriate action. Furthermore, the content of the alert can be customized according to the type and urgency of the detected abnormal behavior, and for example, a stronger warning sound or vibration can be used in cases of high urgency.

Finally, the log recording unit records the history of detected abnormal behavior and alerts. The log includes the date and time, location, detected action, and the content of the displayed alert, so that it can be checked later. This log is utilized as material useful for security improvement and incident investigation. For example, if similar abnormal behavior has been repeated in the past, that pattern can be analyzed and security measures can be strengthened. Also, the log data is also utilized as material for educational institutions to analyze student behavior and provide appropriate guidance.

In this way, the safety of the facility is improved by enhancing security within a facility and detecting abnormal behavior and suspicious persons early. The entire system is designed with scalability in mind and is built to operate stably even when a large number of cameras and sensors are operating simultaneously. This enables introduction in various environments such as educational institutions, commercial facilities, and public facilities, and is expected to contribute to the improvement of safety in society as a whole.

### System Configuration

The system includes a video data acquisition unit, a video analysis unit, an action analysis unit, an anomaly detection unit, an alert display unit, and a log recording unit. The video data acquisition unit has a function of acquiring video data in real time from a plurality of surveillance cameras installed within a facility. These cameras are strategically placed in security-critical areas such as entrances/exits, corridors, elevators, parking lots, emergency stairs, and rooftops. For example, a camera installed at an entrance/exit records all persons entering and exiting the facility and identifies specific persons using face recognition technology. Also, a camera installed in a corridor tracks the movement of persons moving within the facility and detects movements that deviate from normal flow lines. Furthermore, a camera installed in a parking lot is used to monitor the entry and exit of vehicles and to detect suspicious movements. This makes it possible to grasp the overall movement within the facility and to discover abnormal behavior early.

The video analysis unit processes the acquired video data and identifies persons and objects in the video using image recognition technology. For example, it can identify a specific person and track their movement using face recognition technology. It can also detect belongings and vehicles using object recognition technology. This analysis makes it possible to grasp the dynamic elements in the video in detail. Furthermore, by integrating data from multiple cameras and performing three-dimensional motion analysis, the overall situation within the facility is grasped, and more accurate monitoring is realized. For example, by combining video from multiple cameras, it is possible to three-dimensionally reproduce how a person is moving within the facility and to identify movements that are different from normal.

The action analysis unit analyzes patterns of movement of persons and objects based on the data from the video analysis unit. For example, it detects movements that deviate from normal flow lines or actions of staying in a specific area for a long time. Furthermore, it analyzes the speed and direction of movement and identifies actions that are different from normal. For example, it can detect a person moving in a zigzag pattern in a corridor where they should normally move in a straight line. It is also possible to detect unnatural movements in a specific area or a person walking around inside the facility outside of normal business hours. This makes it possible to discover potential threats early and to take appropriate action.

The anomaly detection unit determines the possibility of abnormal behavior or a suspicious person based on the information from the action analysis unit. For example, if a specific behavior pattern that matches past criminal behavior is detected, a warning can be issued immediately. Also, it is periodically updated by referring to a database on a server so as to be able to respond to new trends and expressions. This makes it possible to achieve comprehensive detection by also taking into account new slang popular among young people and unique expressions used in specific cultural spheres. For example, if a specific gesture or movement is a sign of a new criminal behavior, it can be immediately detected and a warning can be issued.

The alert display unit issues a warning to security personnel based on the detection result. The alert is displayed on a surveillance monitor, and notification by voice or vibration is also possible. For example, when abnormal behavior is detected in a specific area, a warning message is displayed along with detailed video of that area. This allows the personnel to quickly grasp the situation on site and take appropriate action. Furthermore, the content of the alert can be customized according to the type and urgency of the detected abnormal behavior, and for example, a stronger warning sound or vibration can be used in cases of high urgency.

The log recording unit records the history of detected abnormal behavior and alerts. The log includes the date and time, location, detected action, and the content of the displayed alert, so that it can be checked later. This log is utilized as material useful for security improvement and incident investigation. For example, if similar abnormal behavior has been repeated in the past, that pattern can be analyzed and security measures can be strengthened. Also, the log data is also utilized as material for educational institutions to analyze student behavior and provide appropriate guidance.

Specific examples of prompt sentences to be read into the generative AI include “Please determine whether the movement of the person in this video differs from the normal pattern,” and “Please evaluate the possibility that a suspicious person is in this area.” These prompt sentences serve as guidelines for the AI to appropriately analyze the video data and make an accurate judgment.

### Implementation Steps

### Step 1: Acquisition of Video Data

Video data is acquired in real time from a plurality of surveillance cameras installed within a facility. These cameras are strategically placed in security-critical areas such as entrances/exits, corridors, elevators, parking lots, emergency stairs, and rooftops. For example, a camera installed at an entrance/exit records all persons entering and exiting the facility and identifies specific persons using face recognition technology. Also, a camera installed in a corridor tracks the movement of persons moving within the facility and detects movements that deviate from normal flow lines. Furthermore, a camera installed in a parking lot is used to monitor the entry and exit of vehicles and to detect suspicious movements.

### Step 2: Video Analysis

The acquired video data is processed, and persons and objects in the video are identified using image recognition technology. For example, it is possible to identify a specific person and track their movement using face recognition technology. It is also possible to detect belongings and vehicles using object recognition technology. This analysis makes it possible to grasp the dynamic elements in the video in detail. Furthermore, by integrating data from multiple cameras and performing three-dimensional motion analysis, the overall situation within the facility is grasped, and more accurate monitoring is realized.

### Step 3: Action Analysis

Patterns of movement of persons and objects are analyzed based on the data from the video analysis unit. For example, movements that deviate from normal flow lines or actions of staying in a specific area for a long time are detected. Furthermore, the speed and direction of movement are analyzed, and actions that are different from normal are identified. For example, it is possible to detect a person moving in a zigzag pattern in a corridor where they should normally move in a straight line. It is also possible to detect unnatural movements in a specific area or a person walking around inside the facility outside of normal business hours.

### Step 4: Anomaly Detection

The possibility of abnormal behavior or a suspicious person is determined based on the information from the action analysis unit. For example, if a specific behavior pattern that matches past criminal behavior is detected, a warning can be issued immediately. Also, it is periodically updated by referring to a database on a server so as to be able to respond to new trends and expressions. This makes it possible to achieve comprehensive detection by also taking into account new slang popular among young people and unique expressions used in specific cultural spheres. Specific examples of prompt sentences to be read into the generative AI include “Please determine whether the movement of the person in this video differs from the normal pattern,” and “Please evaluate the possibility that a suspicious person is in this area.”

### Step 5: Alert Display

A warning is issued to security personnel based on the detection result. The alert is displayed on a surveillance monitor, and notification by voice or vibration is also possible. For example, when abnormal behavior is detected in a specific area, a warning message is displayed along with detailed video of that area. This allows the personnel to quickly grasp the situation on site and take appropriate action. Furthermore, the content of the alert can be customized according to the type and urgency of the detected abnormal behavior, and for example, a stronger warning sound or vibration can be used in cases of high urgency.

### Step 6: Log Recording

The history of detected abnormal behavior and alerts is recorded. The log includes the date and time, location, detected action, and the content of the displayed alert, so that it can be checked later. This log is utilized as material useful for security improvement and incident investigation. For example, if similar abnormal behavior has been repeated in the past, that pattern can be analyzed and security measures can be strengthened. Also, the log data is also utilized as material for educational institutions to analyze student behavior and provide appropriate guidance.

### Specific Use Case

For example, in a certain commercial facility, the system is introduced. Since a large number of visitors come to this facility, enhanced security is required. Within the facility, surveillance cameras are strategically placed in security-critical areas such as entrances/exits, corridors, elevators, parking lots, emergency stairs, and rooftops. These cameras acquire video data in real time and transmit it to a central server.

The video analysis unit processes the acquired video data and identifies persons and objects in the video using image recognition technology. For example, it can identify a specific person and track their movement using face recognition technology. It can also detect belongings and vehicles using object recognition technology. This makes it possible to grasp the dynamic elements in the video in detail.

The action analysis unit analyzes patterns of movement of persons and objects based on the data from the video analysis unit. For example, it detects movements that deviate from normal flow lines or actions of staying in a specific area for a long time. Furthermore, it analyzes the speed and direction of movement and identifies actions that are different from normal. For example, it can detect a person moving in a zigzag pattern in a corridor where they should normally move in a straight line.

The anomaly detection unit determines the possibility of abnormal behavior or a suspicious person based on the information from the action analysis unit. For example, if a specific behavior pattern that matches past criminal behavior is detected, a warning can be issued immediately. Also, it is periodically updated by referring to a database on a server so as to be able to respond to new trends and expressions. This makes it possible to achieve comprehensive detection by also taking into account new slang popular among young people and unique expressions used in specific cultural spheres.

The alert display unit issues a warning to security personnel based on the detection result. The alert is displayed on a surveillance monitor, and notification by voice or vibration is also possible. For example, when abnormal behavior is detected in a specific area, a warning message is displayed along with detailed video of that area. This allows the personnel to quickly grasp the situation on site and take appropriate action.

The log recording unit records the history of detected abnormal behavior and alerts. The log includes the date and time, location, detected action, and the content of the displayed alert, so that it can be checked later. This log is utilized as material useful for security improvement and incident investigation. For example, if similar abnormal behavior has been repeated in the past, that pattern can be analyzed and security measures can be strengthened.

Specific examples of prompt sentences to be read into the generative AI include “Please determine whether the movement of the person in this video differs from the normal pattern,” and “Please evaluate the possibility that a suspicious person is in this area.” These prompt sentences serve as guidelines for the AI to appropriately analyze the video data and make an accurate judgment.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

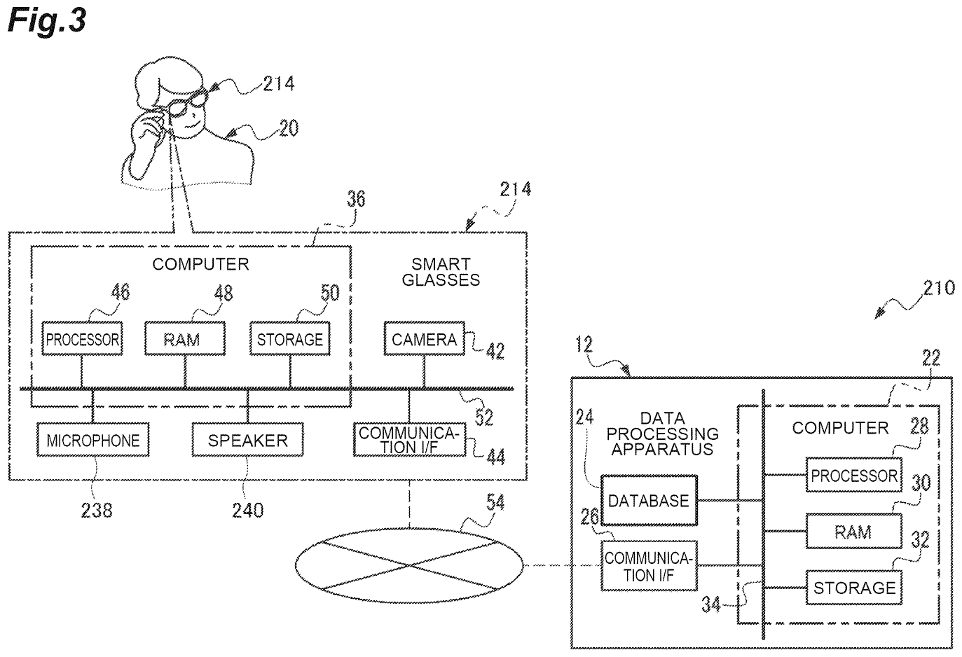

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

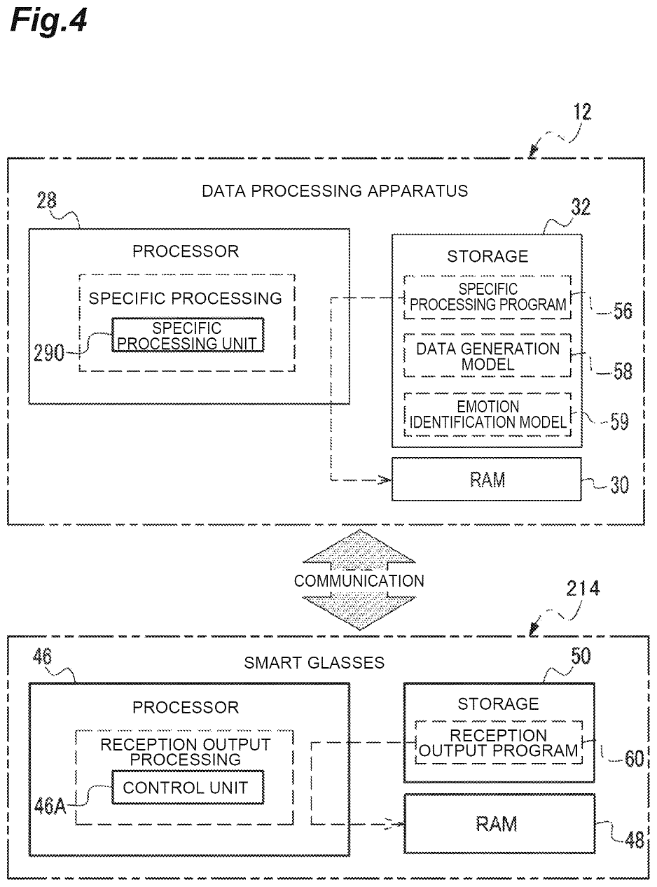

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

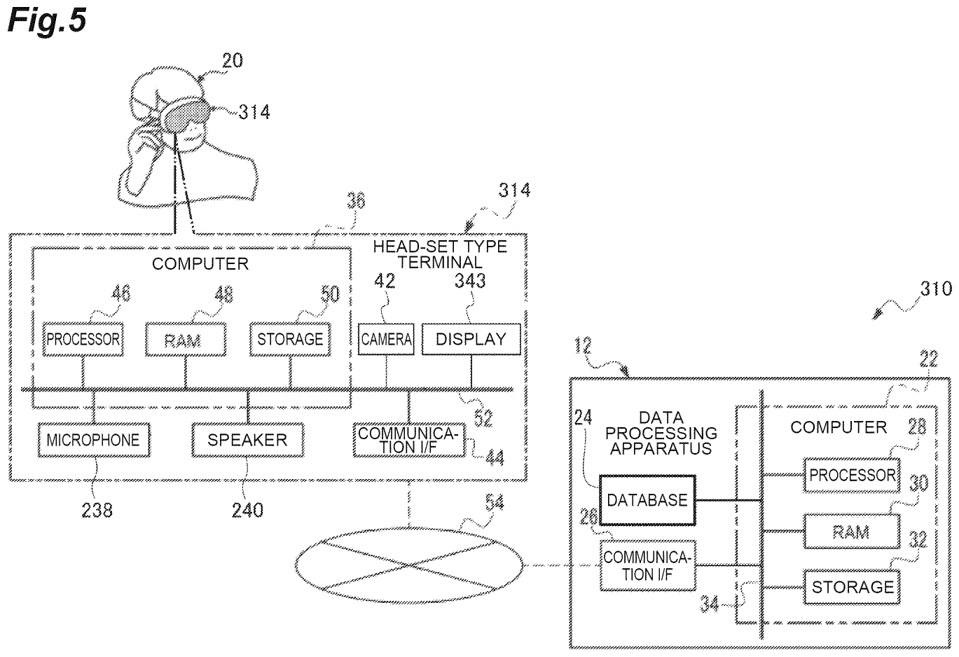

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

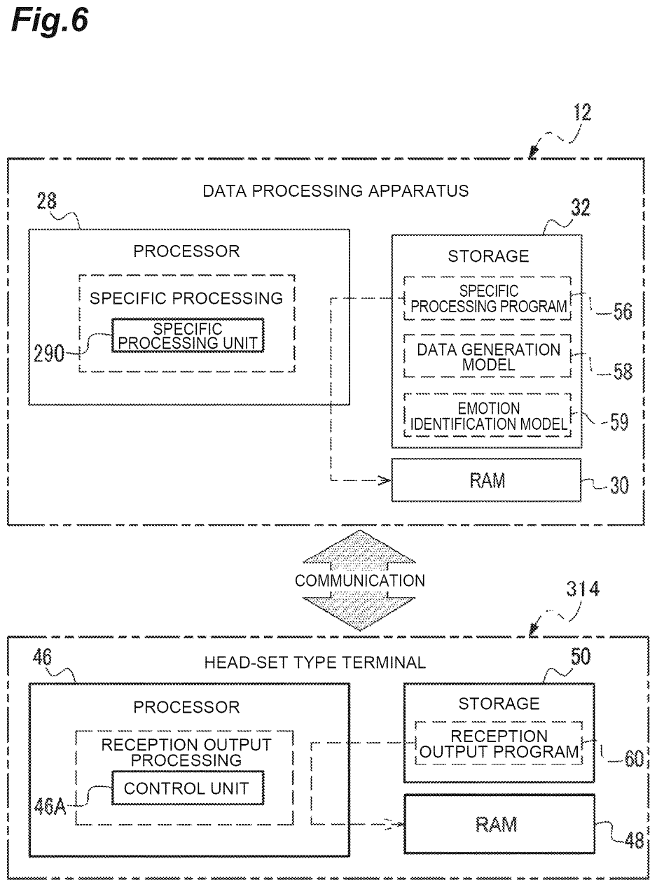

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

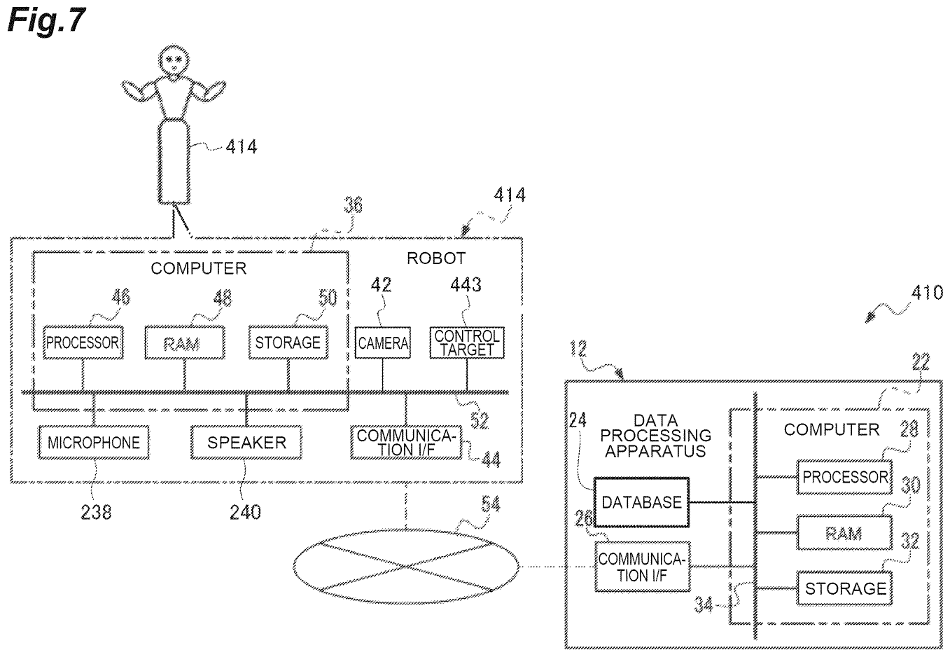

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

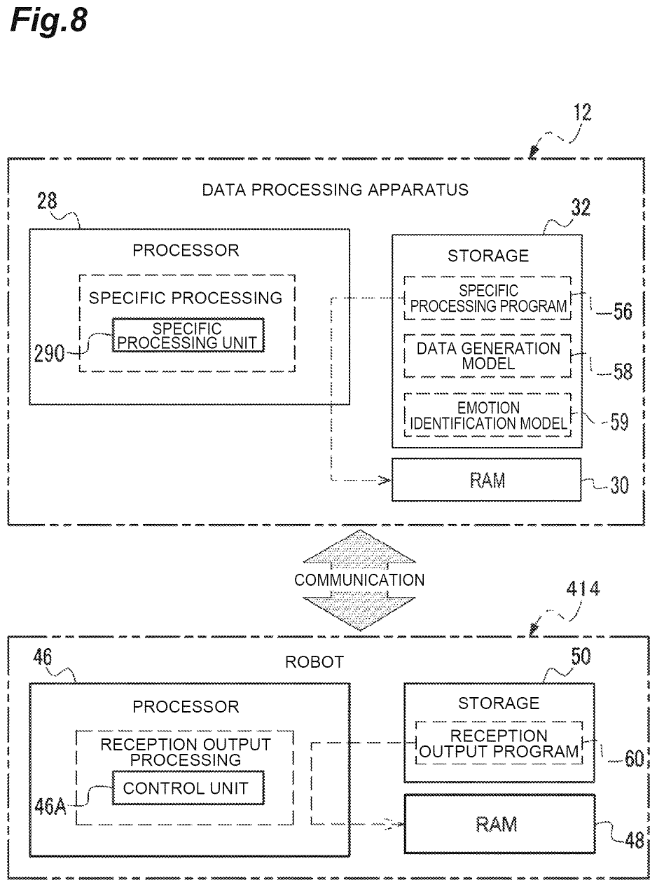

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

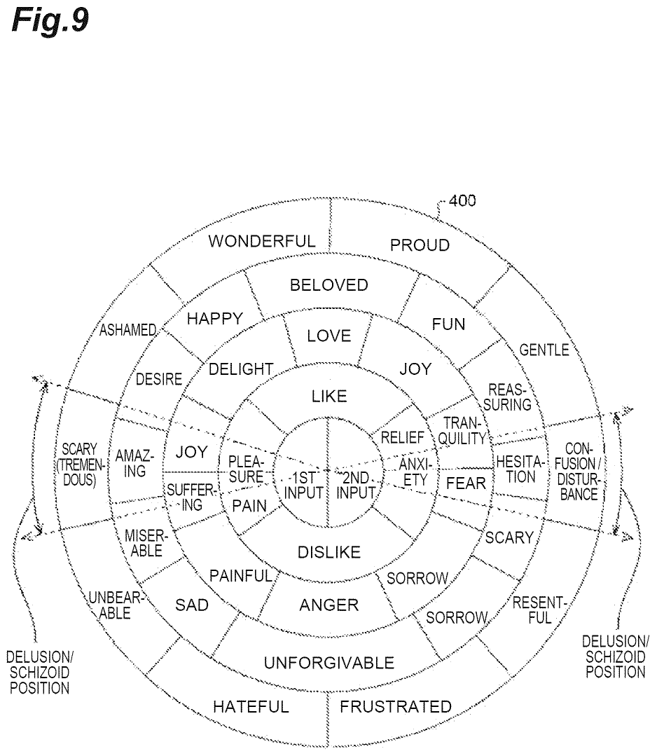

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

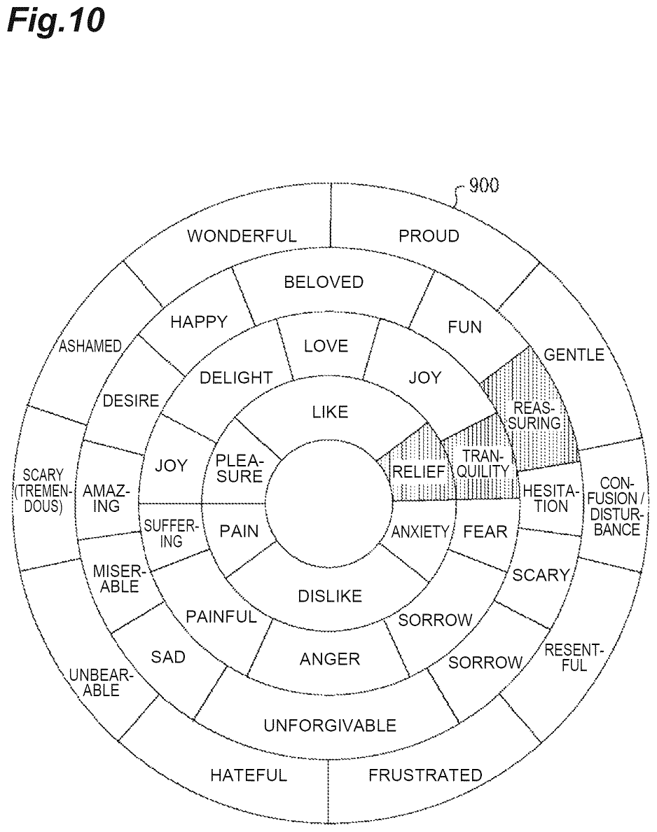

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Processing using the emotion map 400 in the emotion identification model 59 may be performed by, for example, the following coordinate calculation. The emotion map 400 is implemented as a two-dimensional or three-dimensional coordinate system defined on a memory. Feature values (pitch, volume, word vector, etc.) extracted from input voice data or text data are mapped as a point (P_input) on this coordinate system.

The processor 28 calculates a Euclidean distance between the point (P_input) and a center coordinate (C_emotion) of each emotion area, and identifies an emotion area where the distance is minimum. Furthermore, the processor 28 calculates a difference vector (ΔV) between a current emotion coordinate and an immediately preceding emotion coordinate, and calculates a moving speed and direction of the emotion, thereby quantifying stability of a mental state of the user. When this quantified stability parameter falls below a predetermined threshold (that is, when the emotion is fluctuating unstably), feedback control is performed to dynamically increase detection sensitivity (Sensitivity) of the bullying/law violation detection unit. Thereby, an adaptive system that prevents overlooking of dangerous signs while suppressing false positives is realized.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system including a video data acquisition unit, a video analysis unit, an action analysis unit, an anomaly detection unit, an alert display unit, and a log recording unit. The video data acquisition unit has a function of acquiring video data in real time from a plurality of surveillance cameras installed in a facility and transmitting the data to a central server via a network. The video analysis unit processes the acquired video data, identifies persons and objects in the video using image recognition technology, and tracks their movements. The action analysis unit analyzes patterns of movement of persons and objects based on data from the video analysis unit, and detects movements that deviate from normal flow lines or actions of staying in a specific area for a long time. The anomaly detection unit determines the possibility of abnormal behavior or a suspicious person based on information from the action analysis unit, and discovers potential threats early. The alert display unit issues a warning to security personnel based on the detection result, which is displayed on a surveillance monitor and can also be notified by voice or vibration. The log recording unit records the history of detected abnormal behavior and alerts, and generates a log including the date and time, location, detected action, and the content of the displayed alert.

In some examples, the video analysis unit includes a function of identifying a specific person using face recognition technology and tracking their movement, and has a function of detecting belongings and vehicles using object recognition technology. Furthermore, the video analysis unit can integrate data from multiple cameras and perform three-dimensional motion analysis in order to grasp dynamic elements in the video in detail. This makes it possible to grasp the overall situation within the facility and realize more accurate monitoring.

In some examples, the anomaly detection unit includes a function of immediately issuing a warning when a specific behavior pattern consistent with past criminal behavior is detected. Furthermore, the anomaly detection unit is periodically updated by referring to a database on a server so as to be able to respond to new trends and expressions. This makes it possible to achieve comprehensive detection by also taking into account new slang popular among young people and unique expressions used in specific cultural spheres.

An example system for detecting unlawful Internet communications may include circuitry. The circuitry may be configured to: capture a character string input to a terminal by a user; generate information by analyzing a context of the input character string using natural language processing technology; detect, based on the information, whether the input character string indicates a potential violation of a law; display a visual alert for the user on the terminal based on the detection result; and record log data including the detected character string and a display history of the alert in the terminal.

In some examples, capturing the character string may include immediately capturing the character string when the user inputs characters in the terminal by hooking a keyboard input of the terminal.

In some examples, generating the information may include determining an intention of a text or an aggressive expression by processing the input character string with a natural language processing engine and analyzing a meaning of a word or a structure of a sentence.

In some examples, determining the character string may include determining, by referring to a database, whether the character string includes a keyword or phrase related to bullying, or an expression having a possibility of violating a law.

In some examples, displaying the alert may include displaying an alert message indicating a specific problem to the user based on the detection result.

In some examples, recording the log data may include recording the detected character string and the display history of the alert together with a date and time and content of the displayed alert.

An example method of detecting unlawful Internet communications may include: capturing a character string input to a terminal by a user; generating information by analyzing a context of the input character string using natural language processing technology; detecting, based on the information, whether the input character string indicates a potential violation of a law; displaying a visual alert for the user on the terminal based on the detection result; and recording log data including the detected character string and a display history of the alert in the terminal.

What is claimed is:

1. A system for detecting unlawful Internet communications, the system comprising circuitry,
wherein the circuitry is configured to:
capture a character string input to a terminal by a user;
generate information by analyzing a context of the input character string using natural language processing technology;
detect, based on the information, whether the input character string indicates a potential violation of a law;
display a visual alert for the user on the terminal based on the detection result; and
record log data including the detected character string and a display history of the alert in the terminal.

2. The system according to claim 1, wherein capturing the character string includes immediately capturing the character string when the user inputs characters in the terminal by hooking a keyboard input of the terminal.

3. The system according to claim 1, wherein generating the information includes determining an intention of a text or an aggressive expression by processing the input character string with a natural language processing engine and analyzing a meaning of a word or a structure of a sentence.

4. The system according to claim 1, wherein determining the character string includes determining, by referring to a database, whether the character string includes a keyword or phrase related to bullying, or an expression having a possibility of violating a law.

5. The system according to claim 1, wherein displaying the alert includes displaying an alert message indicating a specific problem to the user based on the detection result.

6. The system according to claim 1, wherein recording the log data includes recording the detected character string and the display history of the alert together with a date and time and content of the displayed alert.

7. A method of detecting unlawful Internet communications, the method comprising:
capturing a character string input to a terminal by a user;
generating information by analyzing a context of the input character string using natural language processing technology;
detecting, based on the information, whether the input character string indicates a potential violation of a law;
displaying a visual alert for the user on the terminal based on the detection result; and
recording log data including the detected character string and a display history of the alert in the terminal.
